(19) United States
(12) Patent Application Publication
(10) Pub. No.: US 2008/0167121 A1
(43) Pub. Date: Jul. 10, 2008

(54) Game device, game process control method, and information storage medium

(75) Inventors: Kazuhiro Maeda, Tokyo (JP); Masaki Uchida, Tokyo (JP); Yoshikazu Takenaka, Fujisawa-city (JP); Tetsuo Takahashi, Kawasaki-city (JP); Yuuki Nagamatsu, Yokohama-shi (JP); Kei Kobayashi, Yokohama-shi (JP)

Correspondence Address: OLIFF & BERRIDGE, PLC, P.O. BOX 320850, ALEXANDRIA, VA, 22320-4850, US

(73) Assignee: NAMCO BANDAI GAMES INC., TOKYO (JP)

(21) Appl. No.: 12/000,520

(22) Filed: Dec. 13, 2007

(30) Foreign Application Priority Data
Jan. 9, 2007 (JP) 2007-001839

(51) Int. Cl. G06F 17/00

(52) U.S. Cl. 463/30; 707/104.1; 707/E17.044

(57) ABSTRACT

When a player Pa plays a ghost match against a player Pb, a player's car PC is controlled based on the operation of the player Pa, and a ghost car GC is computer-controlled based on ghost data Gb which is the previous play data of the player Pb. When the player Pa has won the match, the winning player Pa is added to a revenge list of the player Pb as a revenge target player. When the player Pb then plays the game, the player Pb is notified that the ghost car GC of the player Pb has been defeated by the player Pa on the revenge list.

Japanese Patent Application No. 2007-1839 filed on Jan. 9, 2007, is hereby incorporated by reference in its entirety.

### BACKGROUND OF THE INVENTION

The present invention relates to a game device, a program, and an information storage medium.

A racing game has been popular in which players compete in a race while operating (controlling) cars, motorcycles, or the like. Such a racing game has various modes such as a mode in which a player competes with another player for ranking and a mode in which a player competes for speed. A racing game system is known in which a ghost car appears in a game space. A ghost car is computer-controlled based on the player's previous play data which has been stored, and reproduces the previous travel state of the player (see JP-A-2003-320164, for example).

However, a race with a ghost car implemented by a related-art system lacks interest as compared with a race with the actual player. For example, when the player's previous play data is used to control a ghost car, the ghost car controlled based on the play data is the player's ghost car. In this case, since the player is not informed of the match results of the player's ghost car and another player, the player is rarely attached to or interested in the player's ghost car. For example, even if the player's ghost car has lost a match, the player rarely desires to revenge on the other player.

A related-art ghost car is a phantom character which does not actually exist in the game space and does not collide with an object in the game space. Specifically, even if the ghost car travels to overlap the position of the player's car, the ghost car travels without colliding with (contacting) the player's car. Therefore, such a system lacks interest specific to a race such as blocking the opponent racing car by causing the player's car to collide with the opponent racing car, thereby impairing interest in competing for ranking. As a result, such a system merely implements a game play for competing for speed using only the player's car.

### SUMMARY

According to one aspect of the invention, there is provided a game device comprising:

a play data storage section which stores play data of each player recorded in a form available as control data of a computer-controlled character (hereinafter referred to as “COM character”) and identification information of the player while associating the play data with the identification information;

a login section which performs a specific login process to specify a present player;

a play data selection section which selects play data used as an opponent of the present player from the play data stored in the play data storage section;

a match process section which performs a match process by controlling the COM character based on the selected play data and controlling a player's character based on an operation input of the present player;

a match process result storage section which stores the player of the selected play data, the present player, and the match process result of the match process section while associating the player of the selected play data, the present player, and the match process result; and

a revenge match inquiry section which extracts an opponent player who has defeated the COM character controlled based on the play data belonging to the player specified by the login process of the login section and stored in the play data storage section during the match process from the information stored in the match process result storage section, and inquires of the player whether or not to cause the match process section to perform the match process with the COM character controlled based on the play data of the extracted opponent player.

According to another aspect of the invention, there is provided a game device capable of communicating with a server including a play data storage section which stores play data of each player recorded in a form available as control data of a COM character and identification information of the player while associating the play data with the identification information, and a match process result storage section, the game device comprising:

a login section which performs a specific login process to specify a present player;

a COM character selection section which selects a COM character as an opponent of the present player from the play data stored in the play data storage section of the server;

a match process section which performs a match process by controlling the COM character based on the selected play data and controlling a player's character based on an operation input of the present player;

a match process result information storage control section which transmits the match process result of the match process section to the server and causes the match process result to be stored in the match process result storage section of the server while being associated with the player of the selected play data and the present player; and

a revenge match inquiry section which obtains from the server an opponent player who has defeated the COM character controlled based on the play data belonging to the player specified by the login process of the login section and stored in the play data storage section of the server during the match process, and inquires of the player whether or not to cause the match process section to perform the match process with the COM character controlled based on the play data of the opponent player.

### BRIEF DESCRIPTION OF THE SEVERAL VIEWS OF THE DRAWING

FIG. 1 is a configuration diagram showing a game system.

FIG. 2 shows an example of the outward appearance of a game device.

FIG. 3 shows an example of a game screen.

FIG. 4 is a view illustrative of the principle of a ghost match.

FIGS. 5A and 5B are other views illustrative of the principle of a ghost match.

FIGS. 6A and 6B are views illustrative of the principle of a revenge match.

FIGS. 7A and 7B are other views illustrative of the principle of a revenge match.

FIG. 8 is a functional configuration diagram of a game device.

FIG. 9 shows a data configuration example of a game card.

FIG. 10 shows a data configuration example of player management data.

FIG. 11 shows an example of a revenge screen.

FIG. 12 shows an example of a revenge list screen.

FIG. 13 shows a data configuration example of ghost management data.

FIGS. 14A and 14B show a data configuration example of play data.

FIG. 15 shows a data configuration example of travel pattern data.

FIG. 16 shows an example of an opponent selection screen.

FIG. 17 shows an example of an elapsed time coefficient Kt.

FIGS. 18A and 18B show an example of a rubber band coefficient Kr.

FIG. 19 shows a data configuration example of match result data.

FIG. 20 is a flowchart showing an overall process.

FIG. 21 is a flowchart showing a game process performed during the overall process.

FIG. 22 is a flowchart showing a match process performed during the game process.

FIG. 23 is a flowchart showing a data management process performed during the overall process.

FIG. 24 is a flowchart showing a data update process performed during the data management process.

FIG. 25 is a configuration diagram showing a game system including a server.

FIG. 26 shows a configuration example of data stored in a game device and a server device.

FIG. 27 is a flowchart showing processes performed by a game device and a server device.

### DETAILED DESCRIPTION OF THE EMBODIMENT

The invention may increase interest in a match against a ghost car.

According to one embodiment of the invention, there is provided a game device comprising:

a play data storage section which stores play data of each player recorded in a form available as control data of a computer-controlled character (hereinafter referred to as “COM character”) and identification information of the player while associating the play data with the identification information;

a login section which performs a specific login process to specify a present player;

a play data selection section which selects play data used as an opponent of the present player from the play data stored in the play data storage section;

a match process section which performs a match process by controlling the COM character based on the selected play data and controlling a player's character based on an operation input of the present player;

a match process result storage section which stores the player of the selected play data, the present player, and the match process result of the match process section while associating the player of the selected play data, the present player, and the match process result; and

a revenge match inquiry section which extracts an opponent player who has defeated the COM character controlled based on the play data belonging to the player specified by the login process of the login section and stored in the play data storage section during the match process from the information stored in the match process result storage section, and inquires of the player whether or not to cause the match process section to perform the match process with the COM character controlled based on the play data of the extracted opponent player.

According to another embodiment of the invention, there is provided a game process control method comprising causing a computer to:

store play data of each player recorded in a form available as control data of a COM character and identification information of the player while associating the play data with the identification information;

perform a specific login process to specify a present player;

select play data used as an opponent of the present player from the stored play data;

perform a match process by controlling the COM character based on the selected play data and controlling a player's character based on an operation input of the present player;

store the player of the selected play data, the present player, and the match process result while associating the player of the selected play data, the present player, and the match process result;

extract an opponent player who has defeated the COM character controlled based on the stored play data of the player specified by the login process during the match process from the stored information; and

inquire of the player whether or not to cause the match process section to perform the match process with the COM character controlled based on the play data of the extracted opponent player.

According to the above configuration, the match process is performed using the COM character controlled based on the play data selected from the stored play data of each player and the player's character operated by the present logged-in player. When the COM character controlled based on the play data of the present logged-in player has been defeated in the match process, the present logged-in player determines whether or not to play a match against the COM character controlled based on the play data of the opponent player who has defeated the COM character controlled based on the play data of the present logged-in player. Specifically, when the COM character controlled based on the player's play data (i.e., player's COM character) has been defeated by another player, the logged-in player is notified that the player's COM character has been defeated and is informed of the opponent player who has defeated the player's COM character, and can choose whether or not to play a match against the opponent player. This causes the player to desire to play a match against the opponent player who has defeated the player's COM character and win the match, whereby interest in a match with another player can be increased.

According to a further embodiment of the invention, there is provided a game device capable of communicating with a server including a play data storage section which stores play data of each player recorded in a form available as control data of a COM character and identification information of the player while associating the play data with the identification information, and a match process result storage section, the game device comprising:

a login section which performs a specific login process to specify a present player;

a COM character selection section which selects a COM character as an opponent of the present player from the play data stored in the play data storage section of the server;

a match process section which performs a match process by controlling the COM character based on the selected play data and controlling a player's character based on an operation input of the present player;

a match process result information storage control section which transmits the match process result of the match process section to the server and causes the match process result to be stored in the match process result storage section of the server while being associated with the player of the selected play data and the present player; and

a revenge match inquiry section which obtains from the server an opponent player who has defeated the COM character controlled based on the play data belonging to the player specified by the login process of the login section and stored in the play data storage section of the server during the match process, and inquires of the player whether or not to cause the match process section to perform the match process with the COM character controlled based on the play data of the opponent player.

According to still another embodiment of the invention, there is provided a game process control method performed by a computer capable of communicating with a server including a play data storage section which stores play data of each player recorded in a form available as control data of a COM character and identification information of the player while associating the play data with the identification information, and a match process result storage section, the method comprising causing the computer to:

perform a specific login process to specify a present player;

select a COM character as an opponent of the present player from the play data stored in the play data storage section of the server;

perform a match process by controlling the COM character based on the selected play data and controlling a player's character based on an operation input of the present player; transmit the match process result to the server and cause the match process result to be stored in the match process result storage section of the server while being associated with the player of the selected play data and the present player;

obtain from the server an opponent player who has defeated the COM character controlled based on the play data belonging to the player specified by the login process and stored in the play data storage section of the server during the match process; and

inquire of the player whether or not to allow the match process with the COM character controlled based on the play data of the extracted opponent player.

The game device may comprise a data update section which communicates with another game device and updates the information stored in the play data storage sections and the match process result storage sections of the game devices with identical and latest information.

According to the above configuration, the game device communicates with another game device, and the information stored in the game devices is updated with identical and latest information. Specifically, identical and latest information is always stored in different game devices. This enables the player to enjoy a similar game play using any of the game devices.

In the game device, the revenge match inquiry section may inquire of the player whether or not to cause the match process section to perform the match process with the COM character controlled based on the play data of the extracted opponent player during the login process of the login section.

According to the above configuration, the present logged-in player determines whether or not to play a match against the COM character controlled based on the play data of the opponent player who has defeated the present player during the login process. This allows the player to be informed of the opponent player who has defeated the player's COM character during the login process, and the player can then immediately choose the opponent player.

In the game device, the revenge match inquiry section may include a section which first inquires of the player whether or not to cause the match process section to perform the match process with the COM character controlled based on the play data of the opponent player who has most recently defeated the COM character controlled based on the play data of the player.

According to the above configuration, the present logged-in player first determines whether or not to play a match against the COM character controlled based on the play data of the player who has defeated the present player in the latest match.

The game device may comprise a play data update section which updates the play data of the player stored in the play data storage section based on the play data of the player during the match process of the match process section.

According to the above configuration, the play data of the player is updated based on the play data during the match process. Specifically, since the play data is updated for each match process, even if the player plays a match against the COM character of an identical player, the COM character may be controlled in a different way depending on the match date. This implements a game as if actually playing a match against that player.

In the game device,

the play data may be play data of one game play;

the play data storage section may store the play data in units of game-playable game stages; and

the match process section may perform the match process in a game stage corresponding to the selected play data.

According to the above configuration, the play data of one game play is stored in units of game stages, and the match process is performed in the game stage corresponding to the selected play data. Taking a racing game as an example, the play data of one game play is stored in units of game stages which differ in racecourse configuration (e.g., straight and curve). This enables the COM character to be controlled as if the player were actually playing the game.

In the game device,

the match process may be a process of executing a racing game on a given racecourse as a game stage;

the play data may be data for reproducing player's travel play using the COM character; and

the match process section may include:

a contact control section which changes travel states of the COM character and the player's character depending on contact between the COM character and the player's character; and

a recovery control section which causes the COM character of which the travel state has been changed by the contact control section to gradually return to the travel play reproduction state based on the corresponding play data.

According to the above configuration, the travel states of the COM character and the player's character are changed depending on contact between the COM character and the player's character, and the COM character of which the travel state has been changed gradually returns to the travel state based on the corresponding play data. This implements an exciting game play as if playing a match against an actual player (e.g., the travel state of the COM character changes depending on the travel state of the player's car), differing from a related-art ghost car which is a phantom character which does not exist in the game space.

In the game device, the match process section may include a speed adjustment section which adjusts the travel speed of the COM character.

According to the above configuration, the travel speed of the COM character is adjusted.

In the game device, the speed adjustment section may include a first speed adjustment section which adjusts the travel speed of the COM character based on the distance between the COM character and the player's character.

According to the above configuration, the travel speed of the COM character is adjusted based on the distance between the COM character and the player's character. For example, the travel speed of the COM character is adjusted to a larger extent as the distance between the COM character and the player's character becomes larger. Specifically, the travel speed of the COM character is increased when the player's character travels ahead of the COM character, and the travel speed of the COM character is decreased when the player's character travels behind the COM character. The produces a close match between the COM character and the player's character, whereby a more interesting match can be realized.

In the game device,

the play data may include play day information of the play data; and

the speed adjustment section may include a second speed adjustment section which adjusts the travel speed of the COM character based on the number of days elapsed from the play day of the play data used as the control data of the COM character.

According to the above configuration, the travel speed of the COM character is adjusted based on the number of days elapsed from the play day of the play data as the control data of the COM character. For example, the travel speed of the COM character is decreased as the number of days elapsed increases. Therefore, the possibility of winning the match increases as the number of days elapsed from the play day of the play data which controls the COM character increases. In other words, the COM character controlled based on the player's play data is likely to be defeated as the number of days elapsed from the latest play day increases, thereby prompting the player to play the game more frequently.

The game device may comprise an another character control section which controls traveling of another character which is a character other than the COM character controlled based on the play data and is computer-controlled based on a specific control data, and adjusts the travel speed of the other character based on the adjustment of the travel speed of the COM character by the speed adjustment section.

According to the above configuration, the other character computer-controlled based on a specific control data appears in the match process of the COM character and the player's character, and the travel speed of the other character is adjusted based on the adjustment of the travel speed of the COM character. In this case, the control data of the other character may be included in the play data, and the other character may be controlled based on the control data included in the play data when controlling the COM character based on the play data. Since the travel speed of the other character is adjusted based on the adjustment of the travel speed of the COM character, the relative positional relationship between the other character and the COM character is determined uniquely. This realizes control in which the COM character passes the other car at a position corresponding to the position at which the player's character has passed the other car in game play based on the play data which controls the COM character.

According to a still further embodiment of the invention, there is provided a computer-readable information storage medium storing a program for causing a computer to execute the above game process control method.

The term “information storage medium” used herein refers to a storage medium, such as a hard disk, an MO, a CD-ROM, a DVD, a memory card, or an IC memory, from which the stored information can be read by a computer.

According to the embodiment, the match process is performed using the COM character controlled based on the play data selected from the stored play data of each player and the player's character operated by the present logged-in player. When the COM character controlled based on the play data of the present logged-in player has been defeated in the match process, the present logged-in player is informed of the opponent player who has defeated the COM character controlled based on the play data of the present logged-in player. Specifically, when the COM character controlled based on the player's play data (i.e., player's COM character) has been defeated by another player, the logged-in player can be notified that the player's COM character has been defeated and be informed of the opponent player who has defeated the player's COM character. This causes the player to desire to play a match against the opponent player who has defeated the player's COM character and win the match, whereby interest in a match with another player can be increased.

The travel states of the COM character and the player's character are changed depending on contact between the COM character and the player's character, and the COM character of which the travel state has been changed gradually returns to the travel state based on the corresponding play data. This implements an exciting game play as if playing a match against an actual player (e.g., the travel state of the COM character changes depending on the travel state of the player's car), differing from a related-art ghost car which is a phantom character which does not exist in the game space.

Preferred embodiments of the invention are described below with reference to the drawings. The following description illustrates an arcade game device which executes a car racing game. Note that the embodiments to which the invention can be applied are not limited thereto.

### Game System

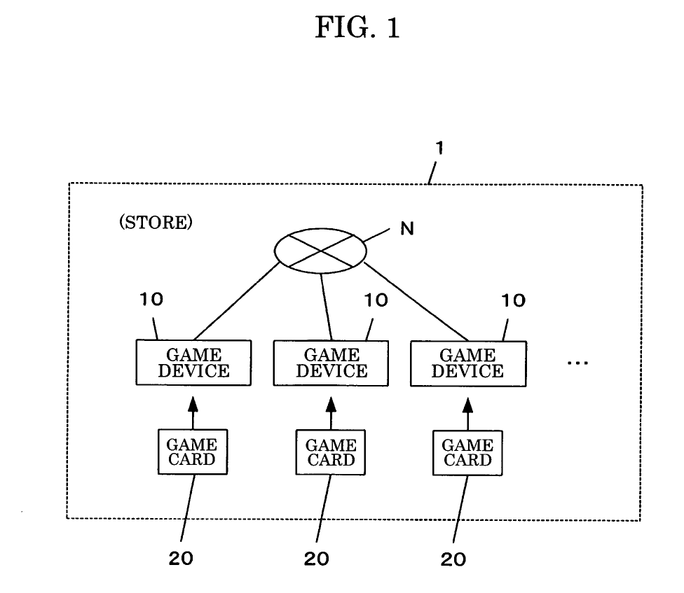

FIG. 1 is a configuration diagram showing a game system 1 according to this embodiment. As shown in FIG. 1, the game system 1 is configured by connecting game devices 10 installed in a single store with a communication line N such as a LAN provided in the store.

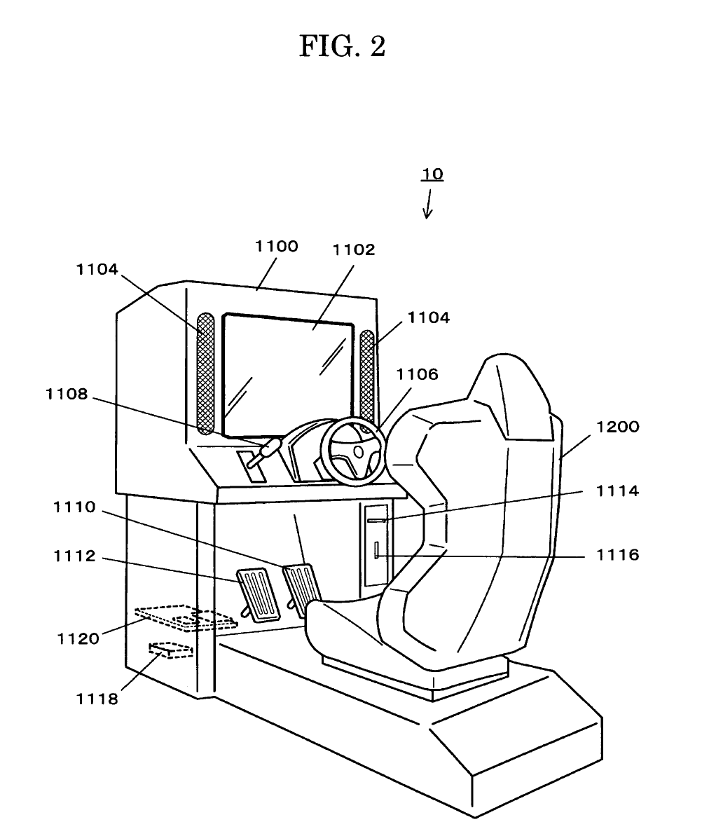

The game device 10 is implemented by an arcade game device, for example. The game device 10 executes a car racing game. FIG. 2 is a view showing an example of the outward appearance of the game device 10. As shown in FIG. 2, the game device 10 is formed to imitate a driver's seat of a racing car, and includes a housing 1100 and a seat 1200. A display 1102 for displaying a game screen, a speaker 1104 for outputting game sound, a steering wheel 1106, a gear lever 1108, an accelerator pedal 1110, and a brake pedal 1112 for a player to input game operations are provided at the front of the housing 1100. A card insertion slot 1114 for inserting a game card 20 and a token insertion slot 1116 for inserting a token, a coin, or the like for playing the game are provided at the lower front of the housing 1100. A player obtains the game card 20 in advance by purchase or the like. The game card 20 is implemented by an IC card including a contact-type IC chip (e.g., mu-chip) in which data such as a specific card ID is recorded. A communication device 1118 for connecting with the communication line N and a control unit 1120 including a CPU, an image generation IC, a sound generation IC, a ROM, a RAM, a hard disk, an IC memory, and the like are provided in the housing 1100. The CPU performs a game process for implementing the car racing game based on a program and data read from the IC memory and the like, data read from the game card 20 inserted into the card insertion slot 1114, operation signals input from the steering wheel 1106 and the like.

The player enjoys the car racing game by operating the steering wheel 1106, the gear lever 1108, the accelerator pedal 1110, and the brake pedal 1112 while watching the game screen displayed on the display 1102 and listening to the game sound output from the speaker 1104.

In the car racing game according to this embodiment, the player operates a player's car (player's character) and plays a match against a ghost car operated by another player (hereinafter called “ghost match”).

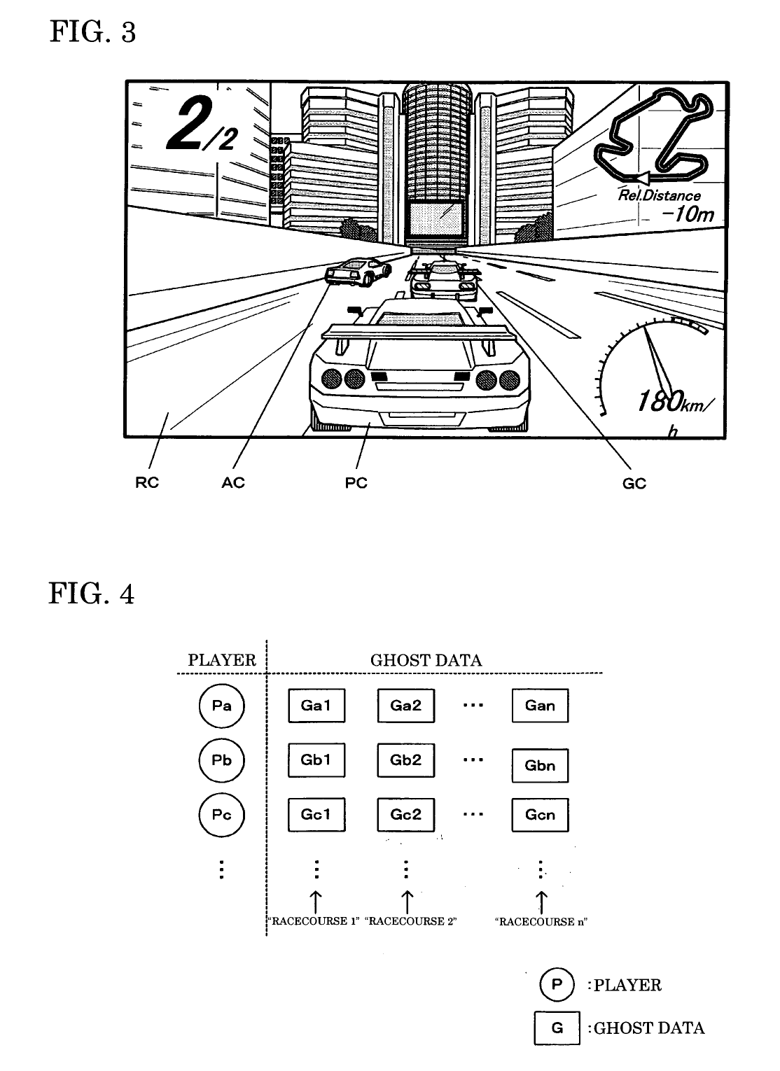

FIG. 3 shows an example of the game screen displayed on the display 1102. As shown in FIG. 3, a player's car PC operated by the player, a ghost car GC operated by another player (opponent player) who is the opponent of the player, and another car AC are displayed in the game screen as racing cars traveling on a racecourse RC. The ghost car GC is a computer-controlled character (COM character) controlled based on ghost data which is the previous play data of the opponent player. Specifically, the player plays a match against the ghost car which reproduces the previous travel state of the opponent player instead of actually playing a match against the opponent player. The other car AC is a character which appears as an obstacle and is not involved in the race. The other car AC is computer-controlled based on specific control data. The player's car PC or the ghost car GC which has reached a finish line preset on the racecourse RC earlier than the other wins the match (race).

### Principle

The principle of the ghost match is described below. In this embodiment, play data when the player plays the game is stored in the game device 10 as ghost data. Specifically, travel data of the player's car PC such as the travel path and the travel speed is stored as the play data.

In this embodiment, two or more racecourses RC are provided, and the ghost data is stored for each racecourse RC. FIG. 4 is a view showing an example of the ghost data stored in the game device 10. As shown in FIG. 4, when n racecourses RC from a racecourse 1 to a racecourse n are provided in total, n pieces of ghost data G1 to Gn for respective racecourses are stored for respective players Pa, Pb, . . . . The ghost match is implemented by controlling the ghost car based on the ghost data of the opponent player stored for the racecourse where the player plays a match. When the match has completed, the ghost data of the player stored for the racecourse where the player has played the match is updated with the play data during the match.

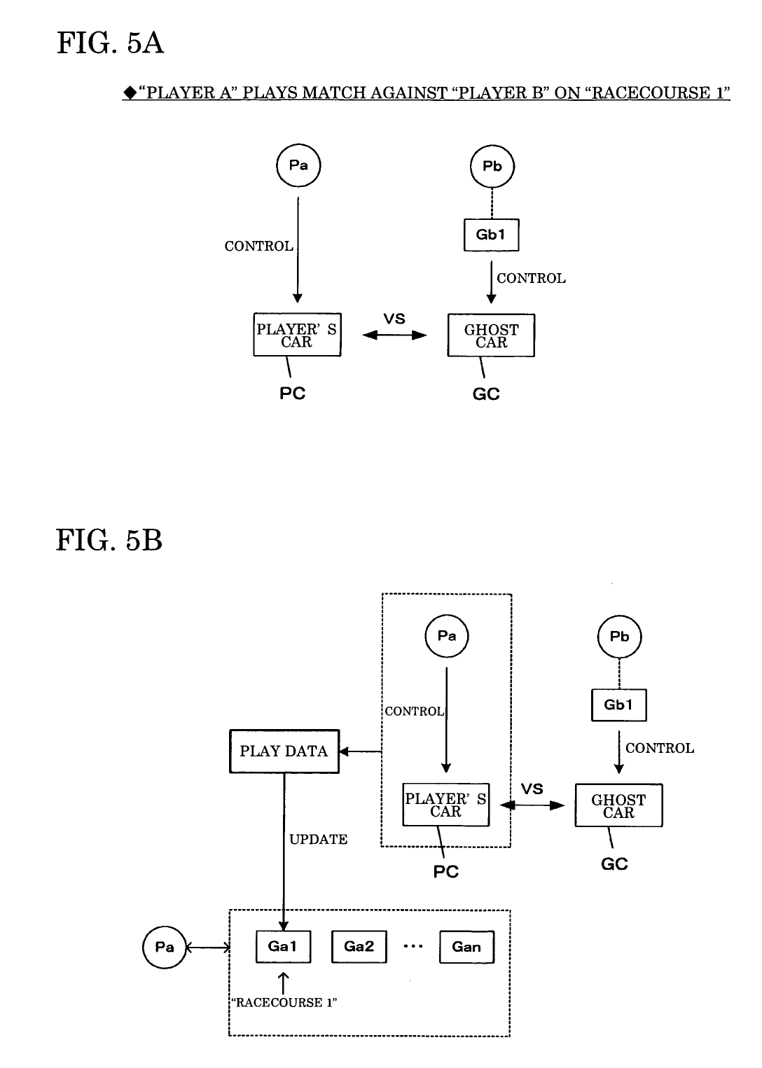

FIGS. 5A and 5B are views showing an example of the ghost match. FIGS. 5A and 5B show the case where the player Pa plays a match against the player Pb on the racecourse 1. As shown in FIG. 5A, the player's car PC is controlled based on the operation of the player Pa. The ghost data Gb1 of the opponent player Pb for the racecourse 1 is selected as the match ghost data, and the ghost car GC is controlled based on the match ghost data Gb1. Therefore, the player Pa can enjoy game play as if the player Pa were actually playing a match against the player Pb on the racecourse 1. When the match has completed, the ghost data Gal of the player Pa for the racecourse 1 is updated with the play data during the match, as shown in FIG. 5B.

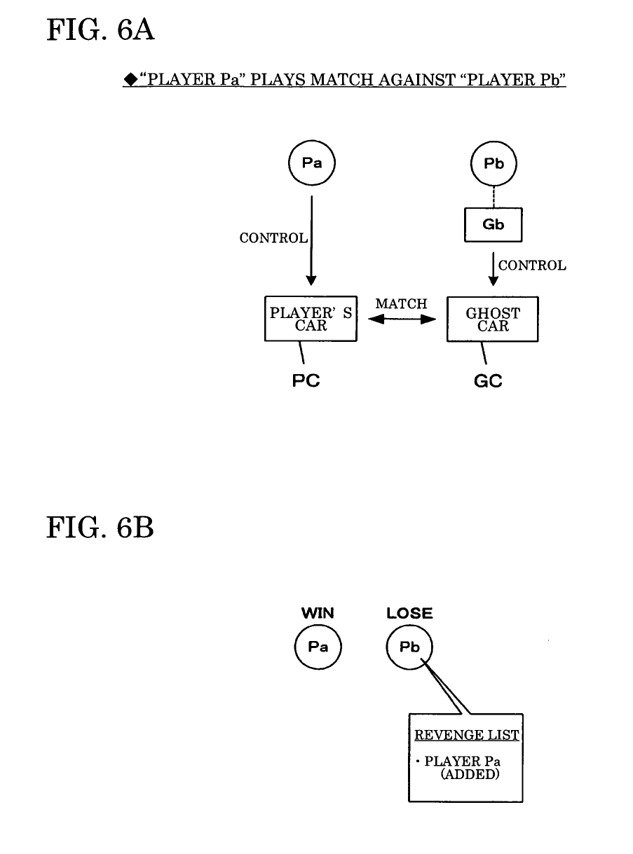

In this embodiment, when the player's ghost car has lost a match, the player can play a revenge match in which the player plays a match against the party player who has won the ghost match. FIGS. 6A and 6B are views illustrative of the revenge match. FIGS. 6A and 6B show an example in which the number of racecourses is one and the ghost data Ga and Gb of the players Pa and Pb is stored as the ghost data G for convenience of description. As shown in FIG. 6A, when the player Pa plays a match against the player Pb, the player Pa operates the player's car PC and plays a match against the ghost car GC controlled based on the ghost data Gb of the player Pb.

As shown in FIG. 6B, when the player Pa has won the match, the winning player Pa is added to a revenge list of the losing player Pb as a revenge target player (revenge player). The revenge list is generated for each player. The revenge list contains a list of the revenge players for the player (i.e., the players who have defeated the ghost car of the player). Specifically, since the ghost car of the player Pb has been defeated by the player Pa, the player Pa is added to the revenge list of the player Pb.

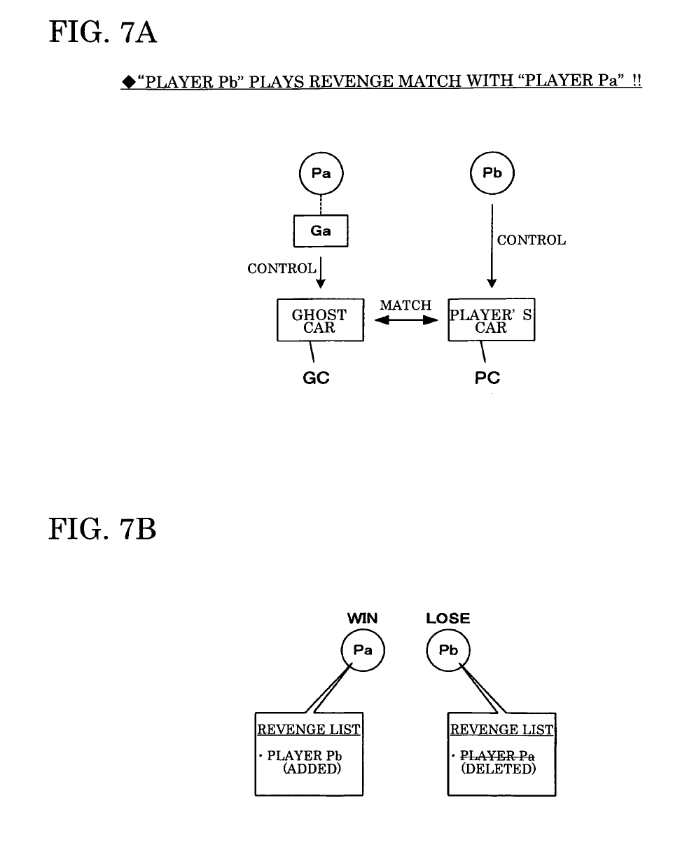

The player plays a match against the player (revenge player) on the revenge list (revenge match), and can revenge on the revenge player by winning the match. FIGS. 7A and 7B show the case where the player Pb plays a revenge match with the player Pa. As shown in FIG. 7A, the player Pb operates the player's car PC and plays a match against the ghost car GC controlled based on the ghost data Ga of the player Pa (revenge player). As shown in FIG. 7B, when the player Pb has defeated the player Pa (i.e., the player Pb has revenged on the player Pa), the player Pa is deleted from the revenge list of the player Pb. On the other hand, since the ghost car of the player Pa has been defeated by the player Pb, the player Pb is added to the revenge list of the player Pa. When the player Pb has been defeated by the player Pa (i.e., the player Pb has not revenged on the player Pa), the revenge lists of the players Pa and Pb do not change.

### Functional Configuration

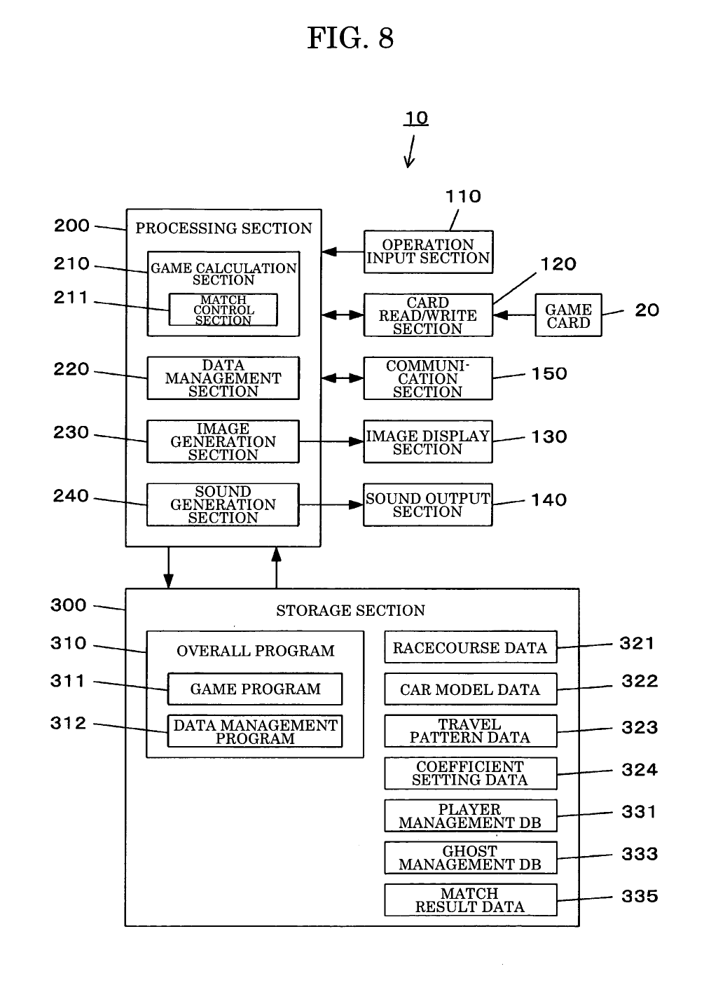

FIG. 8 is a block diagram showing the functional configuration of the game device 10. As shown in FIG. 8, the game device 10 is configured to include an operation input section 110, a card read/write section 120, a processing section 200, an image display section 130, a sound output section 140, a communication section 150, and a storage section 300.

The operation input section 110 receives a player's operation input and outputs an operation signal corresponding to the operation to the processing section 200. The function of the operation input section 110 is implemented by a button switch, a lever, a dial, a mouse, a keyboard, a touch panel, various sensors, and the like. In FIG. 2, the steering wheel 1106, the gear lever 1108, the accelerator pedal 1110, and the brake pedal 1112 correspond to the operation input section 110.

The card read/write section 120 reads data recorded in the game card 20 and outputs the read data to the processing section 200. The card read/write section 120 writes data indicated by a write instruction from the processing section 200 into the game card 20. In FIG. 2, the card insertion slot 1114 corresponds to the card read/write section 120.

The processing section 200 performs various calculations for controlling the entire game device 10, the game process, and the like based on a program and data stored in the storage section 300, operation data input from the operation input section 110, data received from an external device (mainly another game device 10) through the communication section 150, and the like. The function of the processing section 200 is implemented by a calculation device such as a processor (e.g., CPU (CISC or RISC) or DSP) or an ASIC (e.g., gate array) and its control program, for example. In FIG. 2, the CPU mounted on the control unit 1120 corresponds to the processing section 200. The processing section 200 includes a game calculation section 210 which mainly performs game calculations, a data management section 220 which manages various types of data used for the process of the game calculation section 210, an image generation section 230 which generates a game image of a game screen, and a sound generation section 240 which generates game sound such as effect sound and background music (BGM).

The game calculation section 210 includes a match control section 211, and controls execution of the car racing game. Specifically, when the data read from the inserted game card 20 is input from the card read/write section 120, the game calculation section 210 specifies the player based on the input data.

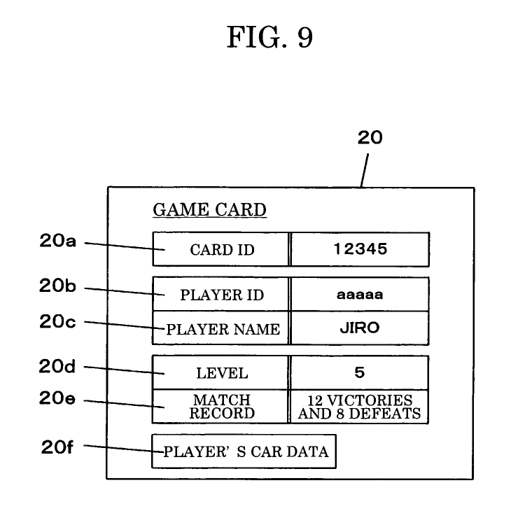

FIG. 9 is a view showing the configuration of data stored in the game card 20. As shown in FIG. 9, a card ID 20a which is the identification number of the game card 20, a player ID 20b of the player possessing the game card 20, a player name 20c, a level 20d, a match record 20e, and player's car data 20f are stored in the game card 20. The player's car data 20f is data relating to the player's car. For example, a model, a body color, a travel distance, and the like are stored as the player's car data 20f. Note that the surface of the game card 20 may be formed as a rewritable printing surface, and some (e.g., player name and level) or all of the recorded data may be rewritably printed on the printing surface.

The game calculation section 210 then refers to a player management DB 331 and determines whether or not a revenge player has been newly added to the revenge list of the specified player. The term “revenge player newly added to the revenge list” refers to a player which has been added to the revenge list after the preceding game play.

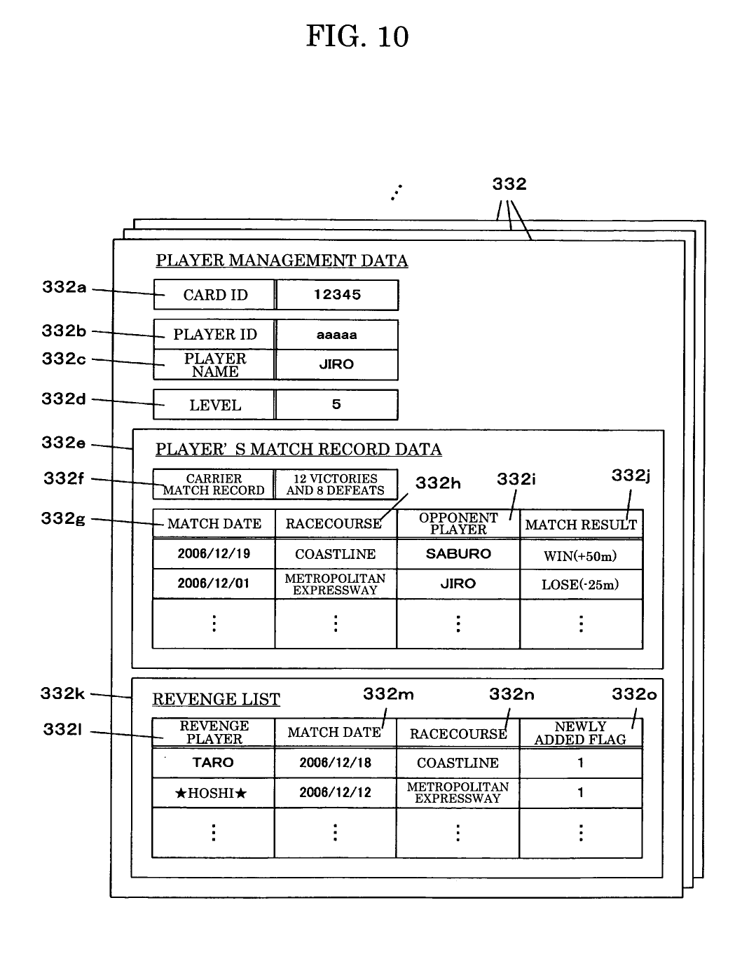

The player management DB 331 is a database (DB) for managing the data relating to the player, and includes two or more pieces of player management data 332. FIG. 10 shows an example of the data configuration of the player management data 332. As shown in FIG. 10, the player management data 332 is generated for each player. A card ID 332a of the game card 20 possessed by the player, a player ID 332b of the player, a player name 332c, a level 332d, player's match record data 332e, and a revenge list 332k are stored as the player management data 332. The player's match record data 332e is the latest match record of the player. A match date 332g, a match racecourse 332h, an opponent player 332i, and a match result 332j of each match are stored as the player's match record data 332e while being associated with one another in addition to a win/lose match record 332f. In the revenge list 332k, a match date 332m, a match racecourse 332n, and a newly added flag 332o are stored for each revenge player 332l while being associated with one another. The newly added flag 332o is a flag indicating whether or not the corresponding revenge player is a player newly added after the preceding game play of the player. The newly added flag 332o is set at “1” when the revenge player is a newly added player. The newly added flag 332o is set at “0” when the player plays the game.

When a revenge player has been newly added to the revenge list of the player, the game calculation section 210 causes the image display section 130 to display a revenge screen prompting the player to revenge on the revenge player whose match date is the latest.

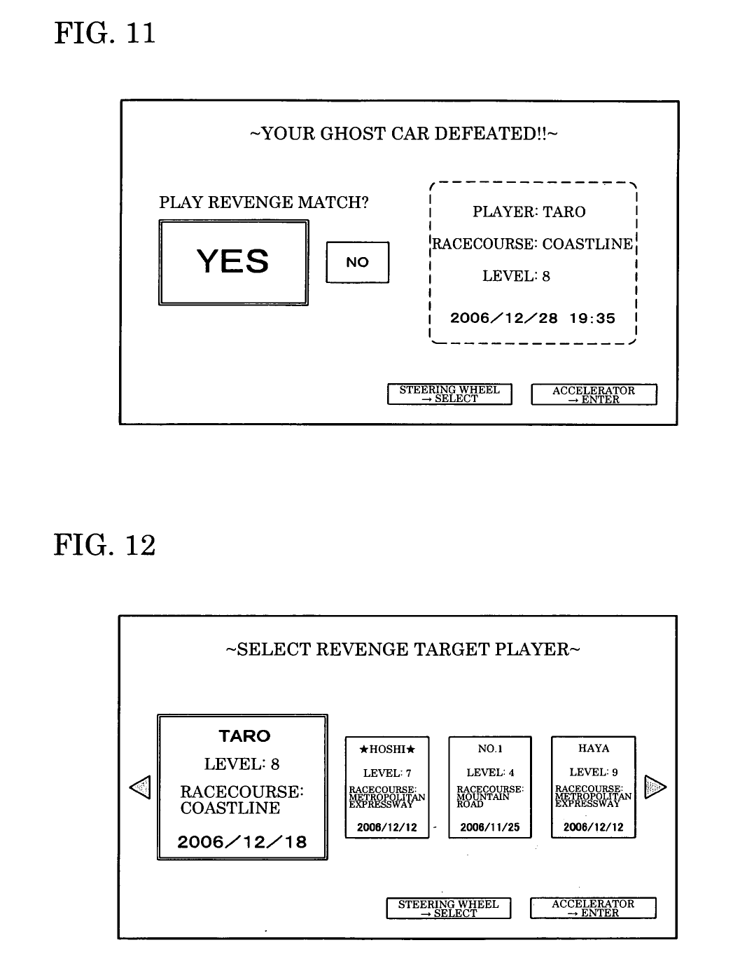

FIG. 11 is a view showing an example of the revenge screen. As shown in FIG. 11, information (e.g., player name, level, match racecourse, and match date) relating to the opponent player (revenge player) who has defeated the player's ghost car after the player's preceding game play and whose match date is the latest is displayed in the revenge screen together with a message inquiring whether or not to play a revenge match with that player. The player can select whether or not to play a revenge match with the displayed player by selecting an icon displayed with the characters “YES” or “NO”.

When the player has selected to play a revenge match using the revenge screen, the latest revenge player is determined to be the opponent player, and the racecourse corresponding to that revenge player is determined to be the match racecourse. A match (revenge match) between the player and the opponent player is carried out on the match racecourse under control of the match control section 211.

When the player does not play a revenge match, the opponent selection method is determined according to operation instructions input from the operation input section 110. The opponent selection method is classified as “selection from the revenge list” and “selection by specifying the level and the racecourse”. When the player selects the opponent player from the revenge list, the game calculation section 210 refers to the player management DB 331 and causes the image display section 130 to display a revenge list screen in which the list of the players stored in the player's revenge list is displayed.

FIG. 12 is a view showing an example of the revenge list screen. As shown in FIG. 12, a list of information (e.g., player name, level, match racecourse, and match date) relating to the opponent player (revenge player) who has defeated the player's ghost car and on whom the player has not revenged is displayed in the revenge list screen. Specifically, a specific number (four in FIG. 12) of players among the revenge players are displayed, and the remaining revenge players are displayed by scrolling the screen in the lateral direction. The player can select the revenge match target player by selecting one of the displayed players.

When the player has selected one of the players using the revenge screen, the game calculation section 210 determines the selected player to be the opponent player, and determines the racecourse associated with that player to be the match racecourse. A match (revenge match) between the player and the opponent player is carried out on the match racecourse under control of the match control section 211.

When the player selects the opponent player by specifying the level and the racecourse, the game calculation section 210 causes the image display section 130 to display a selection screen for selecting the level and the racecourse of the opponent player. When the player has selected the level and the racecourse, the game calculation section 210 extracts the player satisfying the selected level and racecourse referring to the player management DB 331 and a ghost management DB 333.

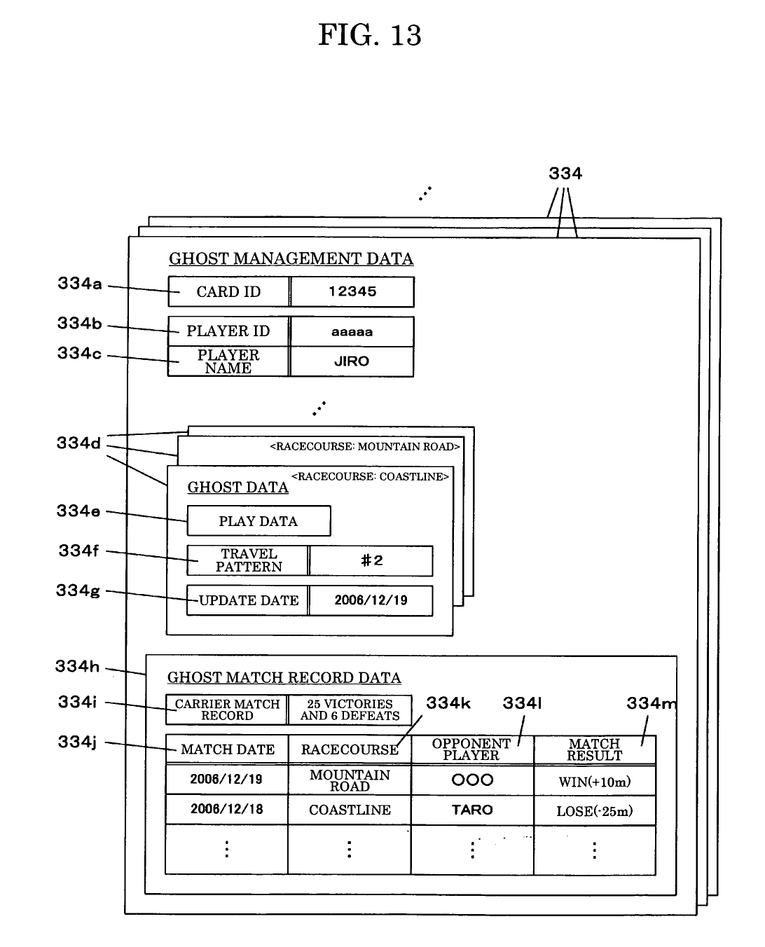

The ghost management DB 333 is a database for managing the data relating to the player's ghost car, and includes two or more pieces of ghost management data 334. FIG. 13 is a view showing an example of the data configuration of the ghost management data 334. As shown in FIG. 13, the ghost management data 334 is generated for each player. A card ID 334a of the game card 20 possessed by the player, a player ID 334b of the player, a player name 334c, ghost data 334d, and ghost match record data 334h are stored as the ghost management data 334. The ghost data 334d is generated for each racecourse. Play data 334e, a travel pattern 334f of the other car, and update date 334 are stored as the ghost data 334d. The play data 334e is travel data of the player's car PC during the previous game play of the player, and includes data relating to the travel path, travel speed, and posture.

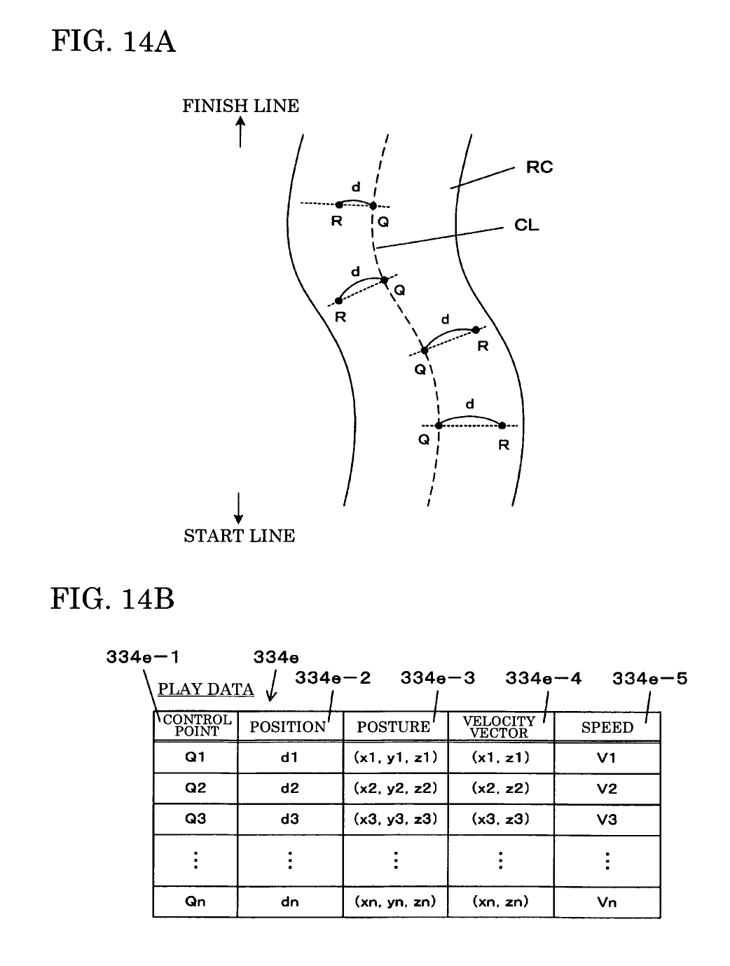

FIG. 14A shows the travel path of the player's car PC. Specifically, control points Q are defined on the racecourse RC along its centerline CL at specific intervals from the start line. The position R of the player's car PC is defined by a distance d from each control point Q in the direction perpendicular to the centerline CL. The distance d is a positive or negative value depending on whether the position R is located on the right or left of the centerline CL with respect to the travel direction. Specifically, the distance d is a positive value when the position R is located on the right of the centerline CL with respect to the travel direction, and is a negative value when the position R is located on the left of the centerline CL with respect to the travel direction.

FIG. 14B is a view showing an example of the data configuration of the play data 334e. As shown in FIG. 14B, a position 334e-2, a posture 334e-3, a velocity vector 334e-4, and a speed 334e-5 are stored as the play data 334e for each control point 334e-1 while being associated with one another.

In FIG. 13, the travel pattern 334f is data indicating the travel pattern (control data) of the other car AC which has traveled along with the player's car PC. Specifically, the identification number of the corresponding travel pattern defined by the travel pattern data 323 is stored as the travel pattern 334f.

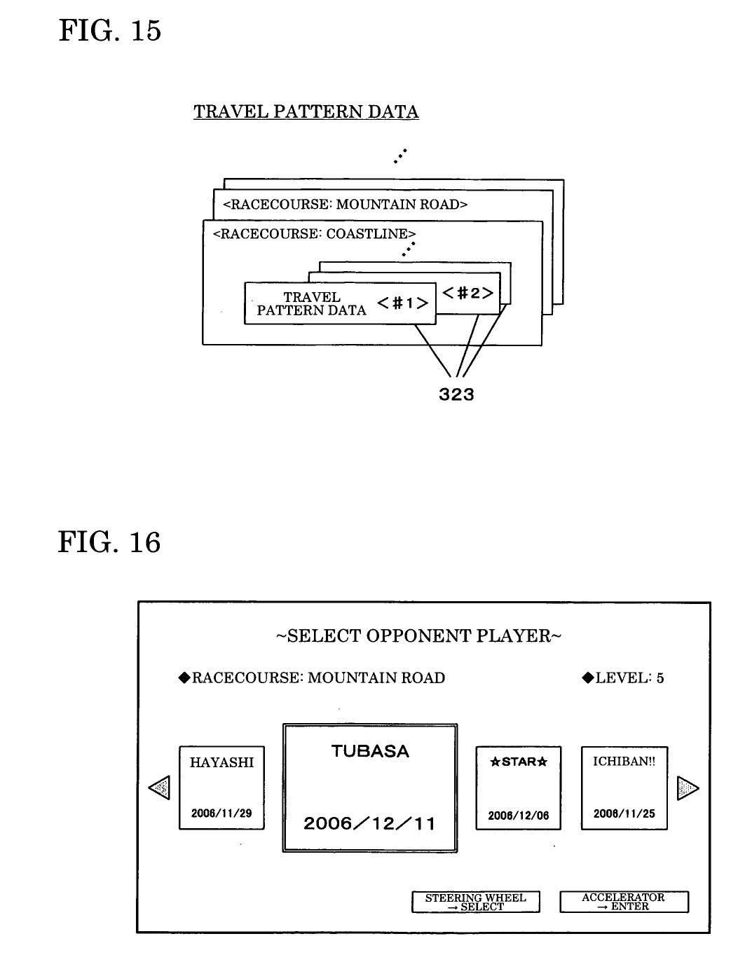

FIG. 15 is a view showing an example of the data configuration of the travel pattern data 323 of the other car AC. As shown in FIG. 15, two or more pieces of travel pattern data 323 are stored for each racecourse. The travel pattern data 323 is a data table which defines the position, the travel speed, the posture, and the like of the other car AC for each control point Q set for the corresponding racecourse RC in the same manner as the play data 334e of the ghost data 334d.

The travel pattern of the other car AC is stored as the ghost data 334d together with the play data 334e of the player's car PC since the player operates the player's car PC so that the player's car PC does not collide with the other car AC while seeing the other car AC. Specifically, the play data 334e which is the travel history data of the player's car PC corresponds to the travel state of the other car AC which has traveled along with the player's car PC.

In FIG. 13, the ghost match record data 334h is the latest match record of the player's ghost car. A match date 334j, a match racecourse 334k, an opponent player 334l, and a match result 334m of each match are stored as the ghost match record data 334h while being associated with one another in addition to a win/lose match record 334i.

In the case where the player selects the opponent player by specifying the level and the racecourse, when the player has selected the level and the racecourse, the game calculation section 210 extracts the player satisfying the selected level referring to the player management DB 331. The game calculation section 210 then extracts the players, for which the ghost data for the selected racecourse has been stored, from the extracted players referring to the ghost management DB 333. The game calculation section 210 causes the image display section 130 to display an opponent selection screen in which the extracted players are listed as opponent candidates.

FIG. 16 is a view showing an example of the opponent selection screen. As shown in FIG. 16, the selected level and racecourse and a list of the names of the players satisfying the selected level and racecourse are displayed in the opponent selection screen. Specifically, a specific number (four in FIG. 16) of players among the players satisfying the selected level and racecourse are displayed, and the remaining players are displayed by scrolling the screen in the lateral direction. The player can select the opponent player by selecting one of the displayed players.

When the player has selected one of the players using the opponent selection screen, the game calculation section 210 determines the selected player to be the opponent player, and determines the racecourse selected in advance to be the match racecourse. A match between the player and the opponent player is carried out on the match racecourse under control of the match control section 211.

The match control section 211 controls a match (ghost match) between the player and the opponent player on the match racecourse. Specifically, the match control section 211 sets the racecourse RC (match racecourse) in a game space, and disposes the player's car PC, the ghost car GC, and the other car AC at the start line. The data relating to each racecourse RC has been stored as the racecourse data 321, and the model data of the racing car has been stored as the car model data 322. The match control section 211 controls the player's car PC based on the player's operation instructions input from the operation input section 110.

The match control section 211 specifies the ghost data 334d for the match racecourse as the match ghost data referring to the ghost management data 334 of the opponent player, and controls the ghost car GC and the other car AC based on the match ghost data 334d. Specifically, the match control section 211 controls the ghost car GC based on the play data 334e of the match ghost data 334d, and controls the other car AC based on the travel pattern data 323 specified by the travel pattern 334f. More specifically, the match control section 211 controls the position and the travel speed of each car so that each car moves (travels) at a specific speed along a specific travel path.

The match control section 211 subjects the player's car PC, the ghost car GC, and the other car AC to a hit check (collision determination), and changes the position of each car based on the hit check results. When the ghost car GC or the other car AC deviates from the specific travel path due to collision (contact), the match control section 211 controls the movement (travel) of the ghost car GC or the other car AC so that the ghost car GC or the other car AC gradually returns to the specific travel path.

The match control section 211 controls the travel speeds of the ghost car GC and the other car AC as follows. Specifically, the match control section 211 determines the speed Vg of the ghost car GC based on the following equation (1a), and determines the speed Va of the other car AC based on the following equation (1b).

Vg=Vg0×Kt×Kr (1a)

Va=Va0×Kt×Kr (1b)

Vg0 in the equation (1a) is the speed of the ghost car GC determined by the play data 334e. Kt is an elapsed time coefficient, and Kr is a rubber band coefficient. Va0 in the equation (1b) is the speed of the other car AC determined by the travel pattern data 323.

The elapsed time coefficient Kt is a parameter for expressing deterioration of the ghost data 334d with the passage of time, and is determined based on the elapsed time T from the update date of the match ghost data 334d to the present date (match start date). The value of the elapsed time coefficient Kt is specified by “0.0<Kt≦1.0”.

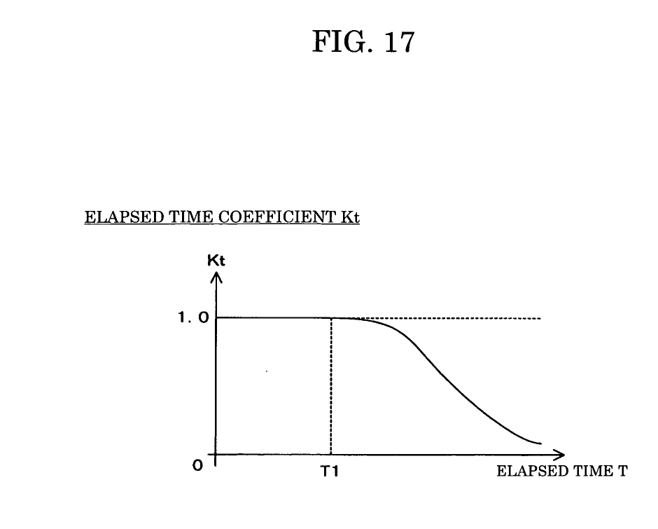

FIG. 17 is a view showing an example of the relationship between the elapsed time T and the elapsed time coefficient Kt. FIG. 17 shows a graph in which the horizontal axis indicates the elapsed time T and the vertical axis indicates the elapsed time coefficient Kt. As shown in FIG. 17, the elapsed time coefficient Kt is constant (1.0) when the elapsed time T is equal to or less than a specific elapsed time T1, and gradually decreases as the elapsed time T increases. This allows a state to be expressed in which the travel speeds of the ghost car GC and the other car AC decrease as the match ghost data 334d becomes older.

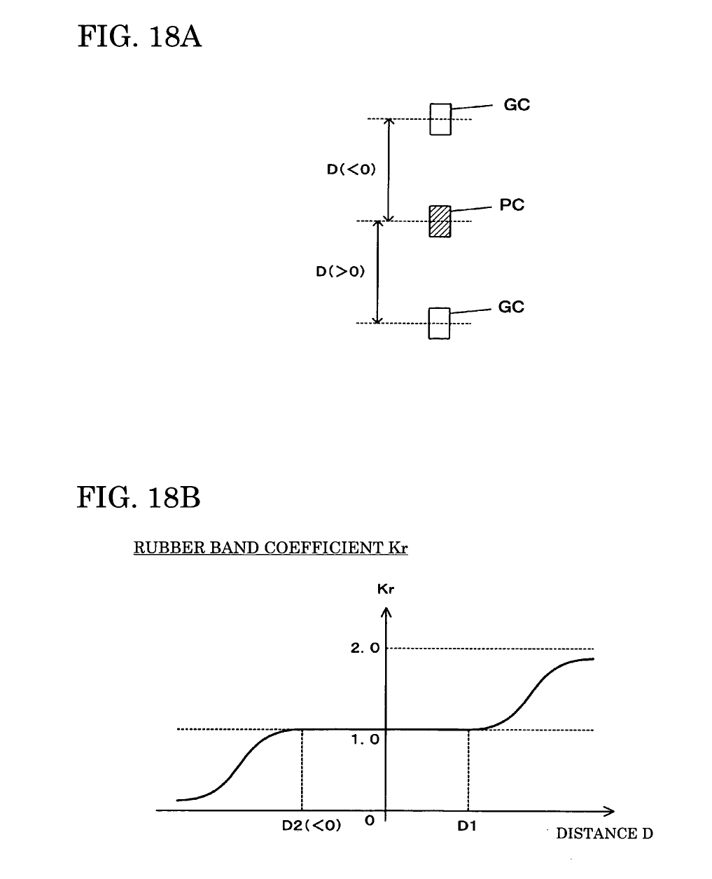

The rubber band coefficient Kr is a parameter for expressing an effect of a virtual rubber (rubber band) which controls the ghost car GC and the other car AC so that the ghost car GC and the other car AC do not move away from the player's car PC to a large extent. The value of the rubber band coefficient Kr is specified by “0.0<Kr≦2.0”. The distance D is a positive or negative value depending on the positional relationship between the player's car PC and the ghost car GC. As shown in FIG. 18A, the distance D is a positive value when the player's car PC is positioned ahead of the ghost car GC in the travel direction, and is a negative value when the player's car PC is positioned behind the ghost car GC in the travel direction.

FIG. 18B is a view showing an example of the relationship between the distance D and the rubber band coefficient Kr. FIG. 18B shows a graph in which the horizontal axis indicates the distance D and the vertical axis indicates the rubber band coefficient Kr. As shown in FIG. 18B, when the distance D is a positive value (i.e., when the ghost car GC is positioned ahead of the player's car PC), the rubber band coefficient Kr is constant (1.0) when the distance D is equal to or shorter than a specific distance D1, and gradually increases as the distance D increases after exceeding the distance D1. On the other hand, when the distance D is a negative value (i.e., when the ghost car GC is positioned behind the player's car PC), the rubber band coefficient Kr is constant (1.0) when the distance D is equal to or longer than a specific distance D2 (<0), and gradually decreases as the distance D decreases in the range in which the distance D is less than the distance D2.

The graphs for determining the elapsed time coefficient Kt and the rubber band coefficient Kr are stored as coefficient setting data 324 in the form of a function formula and a data table indicating the graphs.

The match control section 211 stops controlling the travel state of each car when the player's car PC and the ghost car GC have reached the finish line. The result of the match performed under control of the match control section 211 is stored as match result data 335.

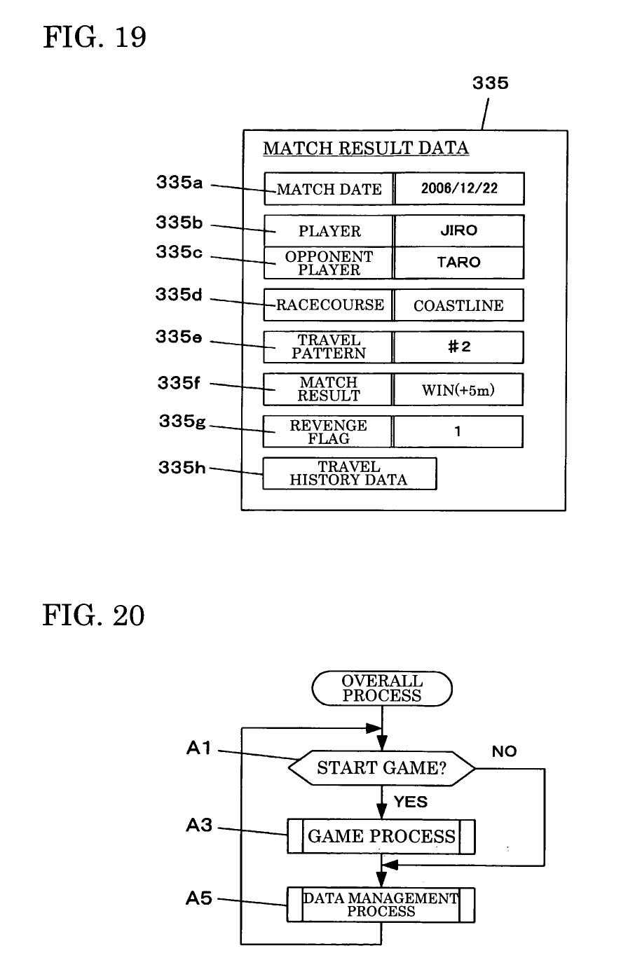

FIG. 19 is a view showing an example of the data configuration of the match result data 335. As shown in FIG. 19, a match date 335a, a player 335b, an opponent player 335c, a match racecourse 335d, a travel pattern 335e of the other car, a match result 335f, a revenge flag 335g, and a travel history data 335h are stored as the match result data 335. The revenge flag 335g is a flag indicating whether or not the match is a revenge match. The revenge flag 335g is set at “1” when the match is a revenge match. The travel history data 335h is data relating to the travel history of the player's car PC. Specifically, the travel history data 335h is data relating to the position, the travel speed, the posture, and the like of the player's car PC at each control point Q defined on the racecourse RC in the same manner as the play data 334e.

The data management section 220 manages the player management DB 331 and the ghost management DB 333. Specifically, when the ghost match controlled by the match control section 211 has completed, the data management section 220 updates the corresponding data based on the generated match result data 335. Specifically, the data management section 220 adds the present match data to the player's match record data 332e of the player management data 332 of the player, and, when the match is a revenge match and the player has won the revenge match, deletes the data of the opponent player stored in the revenge list 332k of the player.

When the player has won the match, the data management section 220 adds the match data to the revenge list 332k of the player management data 332 of the opponent player while adding the player as the revenge player. The data management section 220 updates the match racecourse ghost data 334d of the ghost management data 334 of the player using the travel history data 335h as the play data 334e. The data management section 220 adds the present match data to the ghost match record data 334h of the ghost management data 334 of the opponent player. The data management section 220 distributes the generated match result data 335 to other game devices 10.

When the data management section 220 has received the match result data 335 distributed from another game device 10, the data management section 220 similarly updates the player management DB 331 and the ghost management DB 333 based on the received match result data 335.

In FIG. 8, the image generation section 230 generates a game image for displaying a game screen based on the calculation results of the game calculation section 210, and outputs an image signal of the generated image to the image display section 130. The image display section 130 displays the game screen based on the image signal from the image generation section 230 while redrawing the screen of one frame at specific unit time intervals (e.g., every 1/60 second). The function of the image display section 130 is implemented by hardware such as a CRT, an LCD, an ELD, a PDP, or an HMD. In FIG. 2, the display 1102 corresponds to the image display section 130.

The sound generation section 240 generates game sound such as effect sound and BGM used during the game, and outputs a sound signal of the generated game sound to the sound output section 140. The sound output section 140 outputs the game sound such as effect sound and BGM based on the sound signal from the sound generation section 240. The function of the sound output section 140 is implemented by a speaker or the like. In FIG. 2, the speaker 1104 corresponds to the sound output section 140.

The communication section 150 connects with the communication line based on the control signal from the processing section 200, and communicates data with an external device. The function of the communication section 150 is implemented by a wireless communication module, a jack for a communication cable, a control circuit, or the like. In FIG. 2, the communication device 1118 corresponds to the communication section 150.

The storage section 300 stores a system program for implementing each function for causing the processing section 200 to integrally control the game system 1, a program and data necessary for causing the processing section 200 to execute the game, and the like. The storage section 300 is used as a work area for the processing section 200, and temporarily stores the results of calculations performed by the processing section 200 based on various programs, data input from the operation input section 110, and the like. The function of the storage section 300 is implemented by an IC memory, a hard disk, a CD-ROM, a DVD, an MO, a RAM, a VRAM, or the like. In FIG. 2, the IC memory and the like mounted on the control unit 1120 correspond to the storage section 300. In this embodiment, the storage section 300 stores an overall program 310 for implementing this embodiment including a game program 311 for causing the processing section 200 to function as the game calculation section 210 and a data management program 312 for causing the processing section 200 to function as the data management section 220, and stores the racecourse data 321, the car model data 322, the travel pattern data 323, the coefficient setting data 324, the player management DB 331, the ghost management DB 333, and the match result data 335.

### Process Flow

FIG. 20 is flowchart illustrative of the flow of the overall process of the game device 10. This process is implemented by causing the processing section 200 to execute a process based on the overall program 310. As shown in FIG. 20, when the processing section 200 has determined to start the game in response to insertion of a specific number of coins or the like (step A1: YES), the game calculation section 210 performs the game process (step A3).

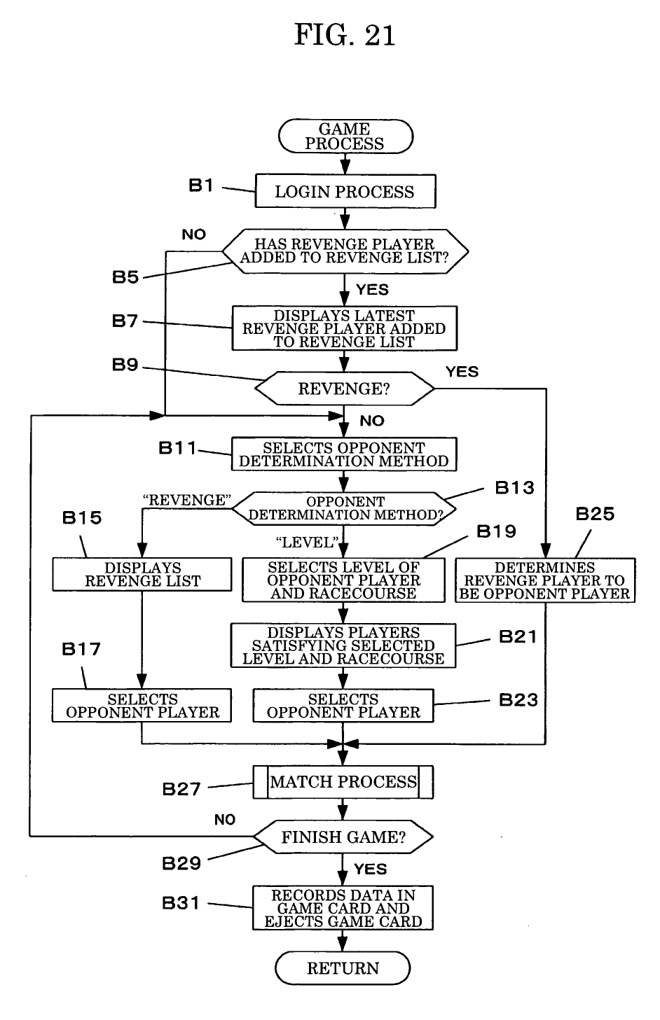

FIG. 21 is a flowchart illustrative of the flow of the game process. As shown in FIG. 21, the game calculation section 210 performs a specific login process to specify the player. Specifically, the game calculation section 210 specifies the player referring to the player management DB 331 based on the data read from the inserted game card 20 and input from the card read/write section 120 (step B1). The game calculation section 210 then refers to the player management DB 331 and determines whether or not a revenge player has been newly added to the revenge list of the specified player.

When the game calculation section 210 has determined that a revenge player has been newly added (step B5: YES), the game calculation section 210 causes the image display section 130 to display the revenge screen (see FIG. 11) prompting the player to revenge on the revenge player whose match date is the latest (step B7). When the player has selected to revenge on the revenge player using the revenge screen (step B9: YES), the game calculation section 210 determines the revenge player to be the opponent player, and determines the racecourse associated with that revenge player in the revenge list to be the match racecourse (step B25). The match control section 211 then performs a match process for allowing the player to play a match against the opponent player on the match racecourse (step B27).

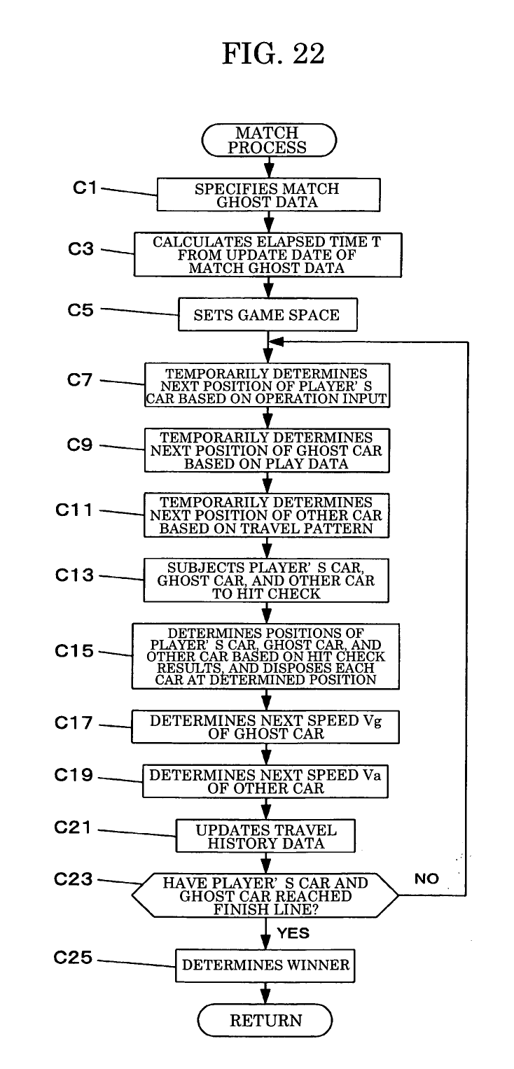

FIG. 22 is a flowchart illustrative of the flow of the match process. As shown in FIG. 22, the match control section 211 refers to the ghost management DB 333 and specifies the ghost data 334d of the opponent player for the match racecourse as the present match ghost data 334d (step C1). The match control section 211 calculates the elapsed time T from the update date of the match ghost data to the present date, and calculates the elapsed time coefficient Kt based on the calculated elapsed time T referring to the coefficient setting data 324 (step C3). The match control section 211 sets the racecourse RC (match racecourse) in the game space, and disposes the player's car PC, the ghost car GC, and the other car AC at the start line (step C5).

The match control section 211 then starts to control each car. Specifically, the match control section 211 temporarily determines the next position of the player's car PC based on the operation instructions input from the operation input section 110 (step C7). The match control section 211 temporarily determines the next position of the ghost car GC based on the play data 334e included in the match ghost data 334d (step C9), and temporarily determines the next position of the other car AC based on the travel pattern data 323 specified by the match ghost data 334d (step C11). The match control section 211 then subjects the player's car PC, the ghost car GC, and the other car AC to a hit check (collision determination) (step C13), determines the position of each car based on the hit check results, and disposes each car at the determined position (step C15).

The match control section 211 then determines the next speed of the ghost car GC. Specifically, the match control section 211 calculates the distance D between the ghost car GC and the player's car PC, and calculates the rubber band coefficient Kr based on the calculated distance D referring to the coefficient setting data 324. The match control section 211 calculates the next speed Vg of the ghost car GC according to the equation (1a) (step C17). The match control section 211 calculates the next speed Va of the other car AC according to the equation (1b) (step C19). The match control section 211 then updates the travel history data 335h by adding the position, the travel speed, the posture, and the like of the player's car PC (step C21).

The match control section 211 then determines whether or not the player's car PC and the ghost car GC have reached the finish line defined on the racetrack RC. When the match control section 211 has determined that the player's car PC and the ghost car GC have not reached the finish line (step 23: NO), the match control section 211 returns to the step C7. When the match control section 211 has determined that the player's car PC and the ghost car GC have reached the finish line (step 23: YES), the match control section 211 determines that the player's car PC or the ghost car GC which has reached the finish line earlier than the other is the winner (step C25). When the above process has been completed, the match control section 211 finishes the match process.

Again referring to FIG. 21, when the player has selected not to revenge on the revenge player using the revenge screen (step B9: NO), the game calculation section 210 selects the opponent determination method based on the player's selection operation (step B11). In this case, when no revenge player is stored in the revenge list of the player, the method of selecting the opponent player from the revenge list may be disabled so that the player necessarily selects the method of selecting the opponent player by specifying the level and the racecourse as the opponent determination method.

When the player has selected the method of selecting the opponent player from the revenge list (step B13: “revenge”), the game calculation section 210 refers to the player management DB 331 and causes the image display section 130 to display the revenge list screen (see FIG. 12) in which a list of the revenge players stored in the player's revenge list is displayed (step B15). The game calculation section 210 selects one of the players displayed in the revenge list screen based on the player's selection operation, determines the selected player to be the opponent player, and determines the racetrack associated with that player in the revenge list to be the match racetrack (step B17). The match control section 211 then performs the match process for allowing the player to play a match against the opponent player on the match racecourse (step B27).

When the player has selected the method of selecting the opponent player by specifying the level and the racecourse (step B13: “level”), the game calculation section 210 selects the level of the opponent player and the match racecourse based on the player's selection instructions input from the operation input section 110 (step B19). The game calculation section 210 then extracts the players satisfying the selected level and racecourse referring to the player management DB 331 and the ghost management DB 333, and causes the image display section 130 to display the opponent selection screen in which a list of the extracted players is displayed (see FIG. 16) (step B21).

The game calculation section 210 selects one of the players displayed in the opponent selection screen based on the player's selection operation, determines the selected player to be the opponent player, and determines the racetrack selected in advance to be the match racetrack (step B23). The match control section 211 then performs the match process for allowing the player to play a match against the opponent player on the match racecourse (step B27).

When the match process has been completed, the game calculation section 210 determines whether or not to finish the game. When the game calculation section 210 has determined to continue the game (step B29: NO), the game calculation section 210 returns to the step B11. When the game calculation section 210 has determined to finish the game (step B29: YES), the game calculation section 210 causes the card read/write section 120 to record data such as the match record in the game card 20 and eject the game card 20 (step B31). When the game calculation section 210 has completed the above process, the game calculation section 210 finishes the game process.

When the game process has been completed, the data management section 220 performs a data management process (step A5).

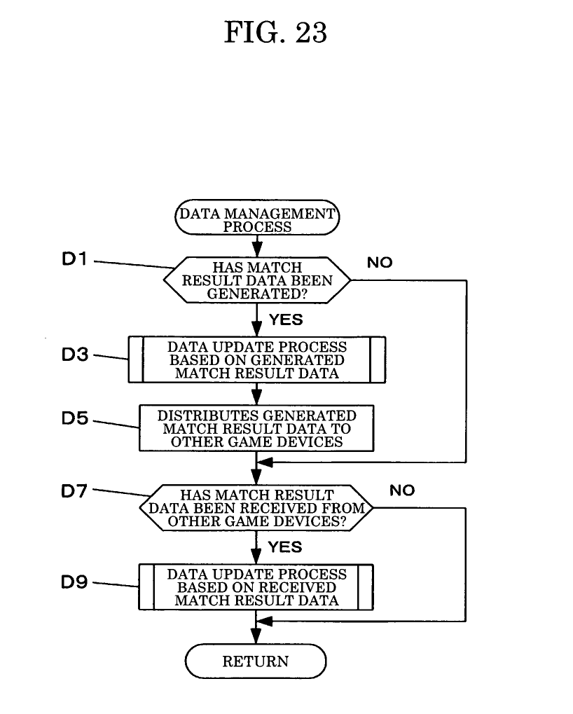

FIG. 23 is a flowchart illustrative of the flow of the data management process. As shown in FIG. 23, when new match result data 335 has been generated as a result of the match control of the match control section 211 (step D1: YES), the data management section 220 performs a data update process based on the generated match result data 335 (step D3).

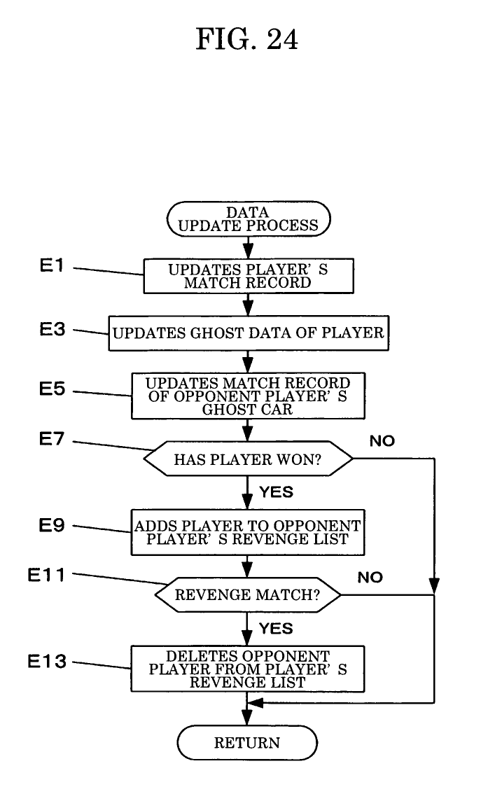

FIG. 24 is a flowchart illustrative of the flow of the data update process. As shown in FIG. 24, the data management section 220 updates the player's match record data 332e of the player management data 332 of the player by adding the present match data (step E1), and updates the match racetrack ghost data 334d of the ghost management data 334 of the player using the travel history data 335h as the play data 334e (step E3). The data management section 220 updates the ghost match record data 334h of the ghost management data 334 of the opponent player by adding the present match data (step E5).

When the player has won the match (step E7: YES), the data management section 220 adds the match data to the revenge list 332k of the player management data 332 of the opponent player while adding the player as the revenge player (step E9). When the match is a revenge match (step E11: YES), the data management section 220 deletes the data of the opponent player stored in the revenge list 332k of the player (step E13). When the data management section 220 has completed the above process, the data management section 220 finishes the data update process.

The data management section 220 then distributes the match result data 335 to other game devices 10 (step D5).

When the data management section 220 has received the match result data distributed from another game device 10 (step D7: YES), the data management section 220 performs the data update process based on the received match result data 335 (step D9). When the data management section 220 has completed the above process, the data management section 220 finishes the data management process. When the data management process has been completed, a similar process is repeated from the step A1.

### Modification

The application of the invention is not limited to the above embodiments. Various modifications and variations may be made within the spirit and scope of the invention.

### (A) Revenge Screen

The above embodiment has been described taking an example in which the latest revenge player among the revenge players newly added to the revenge list of the player is displayed in the revenge screen displayed at the time of login. Note that the revenge player who has defeated the player to the greatest extent (e.g., the revenge player who has reached the finish line at greatest distance from the player) may be displayed, or a list of all revenge players newly added to the revenge list may be displayed, or a list of all revenge players may be displayed.

### (B) Game System

The above embodiment has been described taking a game system configured by connecting the game devices 10 installed in a single store with the communication line N. Note that another configuration may also be employed. For example, a game system may be configured by connecting the game devices 10 installed in different stores with a communication line such as the Internet, or connecting the game devices 10 as consumer game devices with a communication line such a the Internet.

### (C) Server

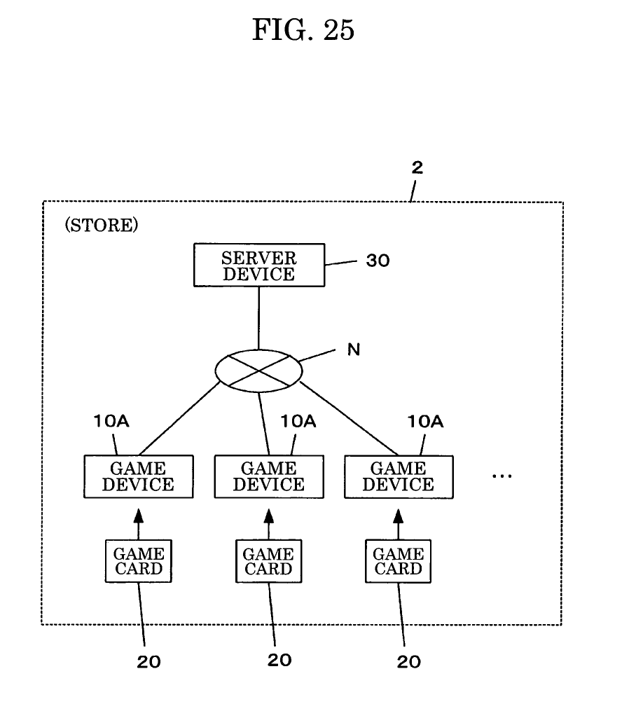

The above embodiment has been described taking a game system configured by connecting the game devices 10 with the communication line N. Note that the game system may further include a server device. FIG. 25 is a diagram showing the configuration of a game system 2 including a server. As shown in FIG. 25, the game system 2 is configured by connecting a server device 30 and game devices 10A with the communication line N. The server device 30 is a known server computer and integrally controls the game system 2. Specifically, the server device 30 collects play data of the player of each game device 10A and manages the play data as ghost data of the player. The server device 30 may be a server system including server computers.

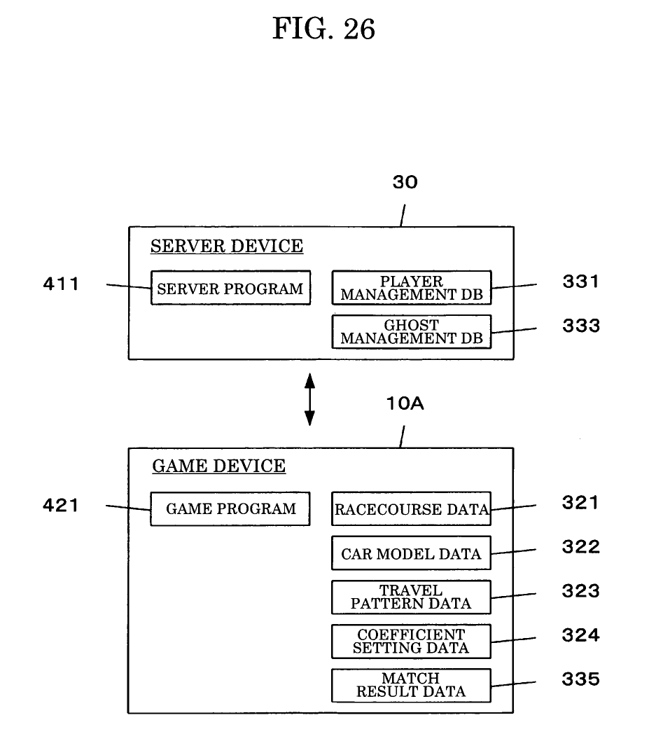

FIG. 26 is a view showing data stored in the server device 30 and the game device 10A. As shown in FIG. 26, the server device 30 stores a server program 411 as a program and stores the player management DB 331 and the ghost management DB 333 as data. The game device 10A stores a game program 421 as a program and stores the racecourse data 321, the car model data 322, the travel pattern data 323, the coefficient setting data 324, and the match result data 335 as data.

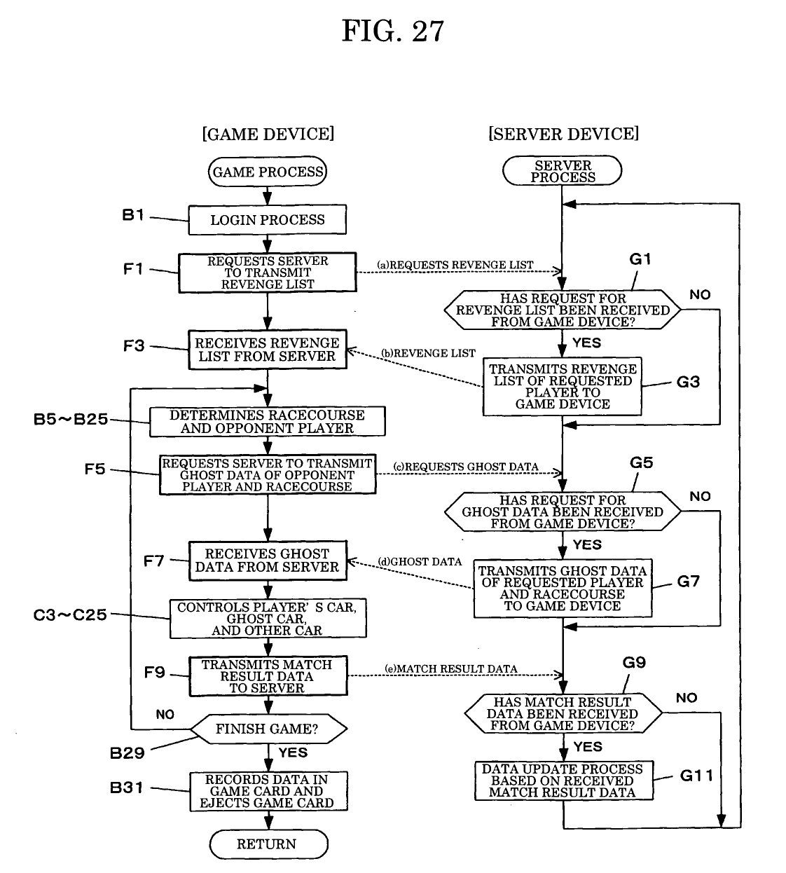

FIG. 27 is a flowchart showing processes performed by the server device 30 and the game device 10A. In FIG. 27, a game process performed by the game device 10A is shown on the left, and a server process performed by the server device 30 is shown on the right. In FIG. 27, the same steps as in FIGS. 21 and 22 are indicated by the same symbols.

As shown in FIG. 27, the game device 10A performs a login process to specify the player (step B1), and requests the server device 30 to transmit the revenge list of the specified player (step F1). When the server device 30 has received the revenge list request from the game device 10A (step G1: YES), the server device 30 refers to the player management DB 331 in response to the request, and transmits the revenge list 332k of the player to the game device 10A (step G3).

When the game device 10A has received the revenge list transmitted from the server device 30 (step F3), the game device 10A determines the match racecourse and the opponent player based on the player's operation input (steps B5 to B25), and requests the server device 30 to transmit the ghost data 334d of the determined opponent player for the match racecourse (step F5). When the server device 30 has received the ghost data request from the game device 10A (step G5: YES), the server device 30 refers to the ghost management DB 333 and transmits the ghost data 334d of the requested player for the requested racecourse to the game device 10A (step G7).

The game device 10A receives the ghost data 334d transmitted from the server device 30 (step F7), and controls the player's car PC, the ghost car GC, and the other car AC based on the received ghost data 334d (steps C3 to C25). When the match has completed, the game device 10A transmits the match result data 335 to the server device 30 (step F9). When the game device 10A has determined to continue the game (step B29: NO), the game device 10A returns to the step B5. When the game device 10A has determined to finish the game (step B29: YES), the game device 10A causes the card read/write section to record the match record and the like in the game card 20 and eject the game card 20 (step B31), and finishes the game process.

When the server device 30 has received the match result data 335 transmitted from the game device 10A (step G9: YES), the server device 30 performs the data update process of updating the corresponding data in the player management DB 331 and the ghost management DB 333 based on the received match result data 335 (step G11). The server device 30 then returns to the step G61.

### (D) Applicable Game Device

The above embodiment illustrates the case of applying the invention to an arcade game device. Note that the invention may also be applied to other game devices such as a consumer game device or a portable game device. Alternatively, the invention may be applied to devices having a communication function such as a portable electronic instrument (e.g., PDA and portable telephone) or a personal computer.

### (E) Applicable Game

The above embodiment illustrates the case of applying the invention to a car racing game. Note that the invention may also be applied to other games in which a player plays a match against a character of another player. For example, when applying the invention to a fighting action game, a player's play tendency data may be stored as the play data. Specifically, the number of operations (or operation frequency) of actions (commands) such as a punch and a kick input by the player during game plays is summed up for each player. A ghost character is stochastically controlled based on the play tendency data. Alternatively, a player's operation data (e.g., button operation record) may be stored as the play data in time series.

Although only some embodiments of the invention have been described above in detail, those skilled in the art would readily appreciate that many modifications are possible in the embodiments without materially departing from the novel teachings and advantages of the invention. Accordingly, such modifications are intended to be included within the scope of the invention.

What is claimed is:

1. A game device comprising:
a play data storage section which stores play data of each player recorded in a form available as control data of a computer-controlled character (hereinafter referred to as “COM character”) and identification information of the player while associating the play data with the identification information;
a login section which performs a specific login process to specify a present player;
a play data selection section which selects play data used as an opponent of the present player from the play data stored in the play data storage section;
a match process section which performs a match process by controlling the COM character based on the selected play data and controlling a player's character based on an operation input of the present player;
a match process result storage section which stores the player of the selected play data, the present player, and the match process result of the match process section while associating the player of the selected play data, the present player, and the match process result; and
a revenge match inquiry section which extracts an opponent player who has defeated the COM character controlled based on the play data belonging to the player specified by the login process of the login section and stored in the play data storage section during the match process from the information stored in the match process result storage section, and inquires of the player whether or not to cause the match process section to perform the match process with the COM character controlled based on the play data of the extracted opponent player.

2. The game device as defined in claim 1, comprising a data update section which communicates with another game device and updates the information stored in the play data storage sections and the match process result storage sections of the game devices with identical and latest information.

3. The game device as defined in claim 1, wherein the revenge match inquiry section inquires of the player whether or not to cause the match process section to perform the match process with the COM character controlled based on the play data of the extracted opponent player during the login process of the login section.

4. The game device as defined in claim 1, wherein the revenge match inquiry section includes a section which first inquires of the player whether or not to cause the match process section to perform the match process with the COM character controlled based on the play data of the opponent player who has most recently defeated the COM character controlled based on the play data of the player.

5. The game device as defined in claim 1, comprising a play data update section which updates the play data of the player stored in the play data storage section based on the play data of the player during the match process of the match process section.

6. The game device as defined in claim 1,
wherein the play data is play data of one game play;
wherein the play data storage section stores the play data in units of game-playable game stages; and
wherein the match process section performs the match process in a game stage corresponding to the selected play data.

7. The game device as defined in claim 1,
wherein the match process is a process of executing a racing game on a given racecourse as a game stage;
wherein the play data is data for reproducing player's travel play using the COM character; and
wherein the match process section includes:
a contact control section which changes travel states of the COM character and the player's character depending on contact between the COM character and the player's character; and
a recovery control section which causes the COM character of which the travel state has been changed by the contact control section to gradually return to the travel play reproduction state based on the corresponding play data.

8. The game device as defined in claim 7, wherein the match process section includes a speed adjustment section which adjusts the travel speed of the COM character.

9. The game device as defined in claim 8, wherein the speed adjustment section includes a first speed adjustment section which adjusts the travel speed of the COM character based on the distance between the COM character and the player's character.

10. The game device as defined in claim 8,
wherein the play data includes play day information of the play data; and
wherein the speed adjustment section includes a second speed adjustment section which adjusts the travel speed of the COM character based on the number of days elapsed from the play day of the play data used as the control data of the COM character.

11. The game device as defined in claim 8, comprising an another character control section which controls traveling of another character which is a character other than the COM character controlled based on the play data and is computer-controlled based on a specific control data, and adjusts the travel speed of the other character based on the adjustment of the travel speed of the COM character by the speed adjustment section.

12. A game device capable of communicating with a server including a play data storage section which stores play data of each player recorded in a form available as control data of a COM character and identification information of the player while associating the play data with the identification information, and a match process result storage section, the game device comprising:
a login section which performs a specific login process to specify a present player;
a COM character selection section which selects a COM character as an opponent of the present player from the play data stored in the play data storage section of the server;
a match process section which performs a match process by controlling the COM character based on the selected play data and controlling a player's character based on an operation input of the present player;
a match process result information storage control section which transmits the match process result of the match process section to the server and causes the match process result to be stored in the match process result storage section of the server while being associated with the player of the selected play data and the present player; and
a revenge match inquiry section which obtains from the server an opponent player who has defeated the COM character controlled based on the play data belonging to the player specified by the login process of the login section and stored in the play data storage section of the server during the match process, and inquires of the player whether or not to cause the match process section to perform the match process with the COM character controlled based on the play data of the opponent player.

13. The game device as defined in claim 12, wherein the revenge match inquiry section inquires of the player whether or not to cause the match process section to perform the match process with the COM character controlled based on the play data of the opponent player during the login process of the login section.

14. The game device as defined in claim 12, wherein the revenge match inquiry section includes a section which first inquires of the player whether or not to cause the match process section to perform the match process with the COM character controlled based on the play data of the opponent player who has most recently defeated the COM character controlled based on the play data of the player.

15. The game device as defined in claim 12, comprising a play data update section which updates the play data of the player stored in the play data storage section based on the play data of the player during the match process of the match process section.

16. The game device as defined in claim 12,
wherein the play data is play data of one game play;
wherein the play data storage section stores the play data in units of game-playable game stages; and
wherein the match process section performs the match process in a game stage corresponding to the selected play data.

17. The game device as defined in claim 12,
wherein the match process is a process of executing a racing game on a given racecourse as a game stage;
wherein the play data is data for reproducing the player's travel play using the COM character; and
wherein the match process section includes:
a contact control section which changes travel states of the COM character and the player's character depending on contact between the COM character and the player's character; and
a recovery control section which causes the COM character of which the travel state has been changed by the contact control section to gradually return to the travel play reproduction state based on the corresponding play data.

18. The game device as defined in claim 7, wherein the match process section includes a speed adjustment section which adjusts the travel speed of the COM character.

19. The game device as defined in claim 17, wherein the speed adjustment section includes a first speed adjustment section which adjusts the travel speed of the COM character based on the distance between the COM character and the player's character.

20. The game device as defined in claim 17,
wherein the play data includes play day information of the play data; and
wherein the speed adjustment section includes a second speed adjustment section which adjusts the travel speed of the COM character based on the number of days elapsed from the play day of the play data used as the control data of the COM character.

21. The game device as defined in claim 17, comprising an another character control section which controls traveling of another character which is a character other than the COM character controlled based on the play data and is computer-controlled based on a specific control data, and adjusts the travel speed of the other character based on the adjustment of the travel speed of the COM character by the speed adjustment section.

22. A game process control method comprising causing a computer to:
store play data of each player recorded in a form available as control data of a COM character and identification information of the player while associating the play data with the identification information;
perform a specific login process to specify a present player;
select play data used as an opponent of the present player from the stored play data;
perform a match process by controlling the COM character based on the selected play data and controlling a player's character based on an operation input of the present player;
store the player of the selected play data, the present player, and the match process result while associating the player of the selected play data, the present player, and the match process result;
extract an opponent player who has defeated the COM character controlled based on the stored play data of the player specified by the login process during the match process from the stored information; and
inquire of the player whether or not to cause the match process section to perform the match process with the COM character controlled based on the play data of the extracted opponent player.

23. A game process control method performed by a computer capable of communicating with a server including a play data storage section which stores play data of each player recorded in a form available as control data of a COM character and identification information of the player while associating the play data with the identification information, and a match process result storage section, the method comprising causing the computer to:
perform a specific login process to specify a present player;
select a COM character as an opponent of the present player from the play data stored in the play data storage section of the server;
perform a match process by controlling the COM character based on the selected play data and controlling a player's character based on an operation input of the present player; transmit the match process result to the server and cause the match process result to be stored in the match process result storage section of the server while being associated with the player of the selected play data and the present player;
obtain from the server an opponent player who has defeated the COM character controlled based on the play data belonging to the player specified by the login process and stored in the play data storage section of the server during the match process; and
inquire of the player whether or not to allow the match process with the COM character controlled based on the play data of the extracted opponent player.

24. A computer-readable information storage medium storing a program for causing a computer to execute the game process control method as defined in claim 22.

25. A computer-readable information storage medium storing a program for causing a computer to execute the game process control method as defined in claim 23.
